(19) United States
(12) Patent Application Publication
(10) Pub. No.: US 2010/0011357 A1
(43) Pub. Date: Jan. 14, 2010

(54) SYSTEM AND METHOD FOR GARBAGE COLLECTION IN A VIRTUAL MACHINE

(75) Inventor: Kiran Ramamurthy, Bangalore (IN)

Correspondence Address: CARPENTER & ASSOCIATES, 5 PIPESTEM COURT, ROCKVILLE, MD, 20854, US

(73) Assignee: INTERNATIONAL BUSINESS MACHINES CORPORATION, Armonk, NY (US)

(21) Appl. No.: 12/172,265

(22) Filed: Jul. 13, 2008

(51) Int. Cl. G06F 9/455; G06F 12/00

(52) U.S. Cl. 718/1; 707/206; 711/E12.001

(57) ABSTRACT

A method includes initializing a virtual machine; and defining a garbage collector configured to perform garbage collection in a process separate from the virtual machine, without a stop-the-world phase. A system and a computer program product are also provided.

### CROSS-REFERENCE TO RELATED APPLICATION

The present application is related to co-pending application, Docket number IN920080052US1/R100033A, entitled “SYSTEM AND METHOD FOR GARBAGE COLLECTION IN A VIRTUAL MACHINE,” filed on the same date as the present application, which application is incorporated herein by reference in its entirety.

### TECHNICAL FIELD

The technical field is directed to memory management in a computer process. The technical field also is directed to virtual machines. The technical field also is directed to garbage collection in a virtual machine.

### SUMMARY OF THE INVENTION

It is known that there are multiple operating systems for computers, such as various versions of Windows™, Linux™, UNIX™, OS/2™, and Macintosh™. Software is compiled differently for each operating system. The compiled, executable, file for a software program designed for one operating system typically cannot run on another operating system.

A “virtual machine” is an operating environment that sits on top of one or more other operating systems. A virtual machine (or runtime environment) is an abstract machine that can include an instruction set, a set of registers, a stack, a heap, and a method area, such as a real machine or processor. A virtual machine acts as an interface between program code and the actual processor. One executable file can run on virtual machines on multiple operating systems so that the same program can be used on different computers running different operating systems. A software program is written and compiled to run on the virtual machine instead of having to be compiled separately for different operating systems. Alternatively, the implementation of a virtual machine can be in code that is built directly into a processor.

A Java virtual machine is one type of virtual machine. The Java platform is a software platform for delivering and running applets and applications on networked computer systems. Java sits on top of other platforms, and executes code which is not specific to any physical machine, but is machine instructions for a virtual machine. A program written in the Java language compiles to a program code known as bytecode that can run wherever the Java platform is present, on any underlying operating system. The Java platform has two basic parts, the Java virtual machine and the Java application programming interface (Java API). The Java virtual machine can either interpret the bytecode one instruction at a time, or the bytecode can be further compiled for the real processor or platform using a just-in-time (JIT) compiler. Other types of virtual machines also exist including Advanced Business Application Programming Language virtual machines, and Common Language Runtime virtual machines.

When executing, the virtual machines create and refer to multiple local data entities such as strings, constants, variables, objects, instances of a class, runtime representations of a class, and class loaders. When a local entity stops being used by a virtual machine, the memory that was allocated for it needs to be freed up (released or reclaimed) so that it can be available for other uses.

Garbage collection is a process to reclaim blocks of memory that were allocated by a memory allocator but that are no longer being used. Whether a memory block is no longer being used can be determined by looking for blocks that are no longer reachable from any currently referenced objects or entities. These functions are performed by a garbage collector.

The garbage collector has been an integral part of the Java virtual machine for memory management. This component takes care of memory management for the Java virtual machine and is described, for example, in U.S. Patent Application Publication US 2003/0196061 A1, Kawahara et al.; in U.S. Patent Application Publication US 2005/0278497 A1, Pliss et al.; in U.S. Patent Application Publication 2006/0059453 A1, Kuck et al.; and in U.S. Pat. No. 6,865,657 to Traversat et al., all of which are incorporated herein by reference.

In addition to managing memory, the garbage collector is also responsible for creation of a Java heap and also allocation of objects within the heap. A heap is an area of memory where Java objects are allocated. Allocation of heap refers to creation of Java heap at the start up of the virtual machine. This gives a boundary within which the garbage collector can manage memory.

Object allocation is an activity where a portion of memory is requested and allocated for an object. Whenever a new operator is encountered in the Java application, it means a new object needs to be created. This object needs some amount of memory depending on the type of object. Using the information regarding the type of object, which determines the size of memory needed, the virtual machine allocates a portion of memory on the Java heap for this object. The virtual machine also maintains a reference to the location.

Because garbage collection is a housekeeping job, it does not really contribute to the throughput of a Java application. Garbage collection, as an automatic memory management tool, takes place despite the negative impact to throughput. The Java application will cease to run if there is complete exhaustion of memory in the heap.

The garbage collector first performs a task called marking. During marking, the garbage collector traverses an application graph, starting with root objects (objects that are represented by all active stack frames) and all the static variables loaded into the system. Objects that are alive that the garbage collector meets are marked as being used.

Then the garbage collector performs a task called sweeping. During sweeping, objects that were not marked are deleted. In other words, dead objects are deleted during the sweeping.

Defragmenting can also take place to compact memory by moving objects closer to each other, removing any fragments of free space. This is referred to as compacting.

In a technique called generational collection, memory is divided into generations. Objects that survive some number of young generation garbage collections are promoted or tenured to an old generation. Old generation garbage collections are performed less frequently.

Garbage collection is described in greater detail in a paper titled “Memory Management in the Java Hotspot™ Virtual Machine,” Sun Microsystems, April 2006, available from Sun's website, and incorporated herein by reference.

Garbage collection runs as a stop-the-world phase in a Java virtual machine, where all threads are suspended and only the garbage collector is allowed to run until its completion. Threads are entities, which execute specific individual tasks. Modern operating systems and applications are multi-threaded, meaning that they accommodate multiple tasks being performed in parallel.

Even garbage collectors that have concurrent marking, sweeping and compacting phases still run as a stop-the-world phase. There are still pause times when a garbage collector is running, which reduces throughput.

To minimize the intervention of garbage collection with the productive time of a virtual machine, some embodiments of this disclosure provide a configuration where actual garbage collection is performed outside the virtual machine process.

Some aspects provide a method including initializing a virtual machine; and defining a garbage collector configured to perform garbage collection in a process separate from the virtual machine, without a stop-the-world phase.

Other aspects provide a system including a memory; a virtual machine, the virtual machine being configured to define a heap in the memory; and a garbage collector configured to be selectively forked out by the virtual machine and to perform garbage collection on the heap, without a stop-the-world phase.

Thus, at least some aspects and embodiments of this disclosure are directed a method including; initializing a virtual machine; and defining a garbage collector configured to perform garbage collection in a process separate from the virtual machine, without a stop-the-world phase. In at least some aspects and embodiments, the garbage collector is forked out during virtual machine initialization. In at least some aspects and embodiments, the virtual machine has a heap on a shared memory, and the garbage collection is performed on the heap. In at least some aspects and embodiments, the garbage collection includes marking and sweeping of the heap. In at least some aspects and embodiments, the garbage collection further includes compaction. In at least some aspects and embodiments, the garbage collector shares at least some data structures with the virtual machine. In at least some aspects and embodiments, the virtual machine, not the garbage collector, performs initial allocation of objects in a heap. In at least some aspects and embodiments, the garbage collector has data structures that are not shared with the virtual machine. In at least some aspects and embodiments, garbage collection occurs during time slices. In at least some aspects and embodiments, the virtual machine and garbage collector operate in a deterministic manner.

At least some aspects and embodiments of this disclosure are directed to a system including: a memory; a first virtual machine, the first virtual machine being configured to define a heap in the memory; and a garbage collector configured to be selectively forked out by the first virtual machine and to perform garbage collection on the heap, without a stop-the-world phase. In at least some aspects and embodiments, the system further comprises a second virtual machine, where the garbage collector is configured to perform garbage collection for both the first and second virtual machines. In at least some aspects and embodiments, the garbage collector is configured to mark and sweep the heap. In at least some aspects and embodiments, the garbage collector is further configured to compact the heap. In at least some aspects and embodiments, the first virtual machine, not the garbage collector, is configured to perform initial allocation of objects in the heap. In at least some aspects and embodiments, the garbage collector has data structures that are not shared with the first virtual machine. In at least some aspects and embodiments, the system further includes a processor configured to allocate processor time slices, where different processes are configured to run in different interleaved time slices, and where the garbage collector operates during allocated time slices. In at least some aspects and embodiments, the virtual first machine and garbage collector are configured to operate in a deterministic manner.

At least some aspects and embodiments of this disclosure are directed to a computer program product including a computer useable medium having a computer readable program, where the computer readable program when executed on a computer causes the computer to: initialize a virtual machine, the virtual machine creating a heap and allocating objects on the heap; fork out a garbage collector from the virtual machine, the garbage collector configured to perform garbage collection on the heap, the garbage collection including marking and sweeping, without a stop-the-world phase. In at least some aspects and embodiments, the garbage collector is configured to share at least some data structures with the virtual machine.

### BRIEF DESCRIPTION OF THE VIEWS OF THE DRAWINGS

FIG. 1 is a block diagram of a system in accordance with various embodiments.

FIG. 2 is a block diagram of a system in accordance with various more detailed embodiments.

FIG. 3 is a block diagram of a system in accordance with various alternative embodiments.

FIG. 4 is a timing diagram of a system in accordance with various embodiments.

### DETAILED DESCRIPTION OF THE ILLUSTRATED EMBODIMENTS

The prior art design of Java virtual machines uses an in-proc garbage collector which is spawned as a thread (or a set of threads) which starts at the initialization of the Java virtual machine. In-proc refers to an activity which is performed within a process context. An in-proc activity is completely performed within the running process using the resources allocated to the process by the operating system. Threads are entities which execute specific individual tasks.

The tasks performed by the garbage collector can be separated into allocation (of a heap and objects in the heap) and the actual garbage collection (e.g., mark-sweep-compact phases).

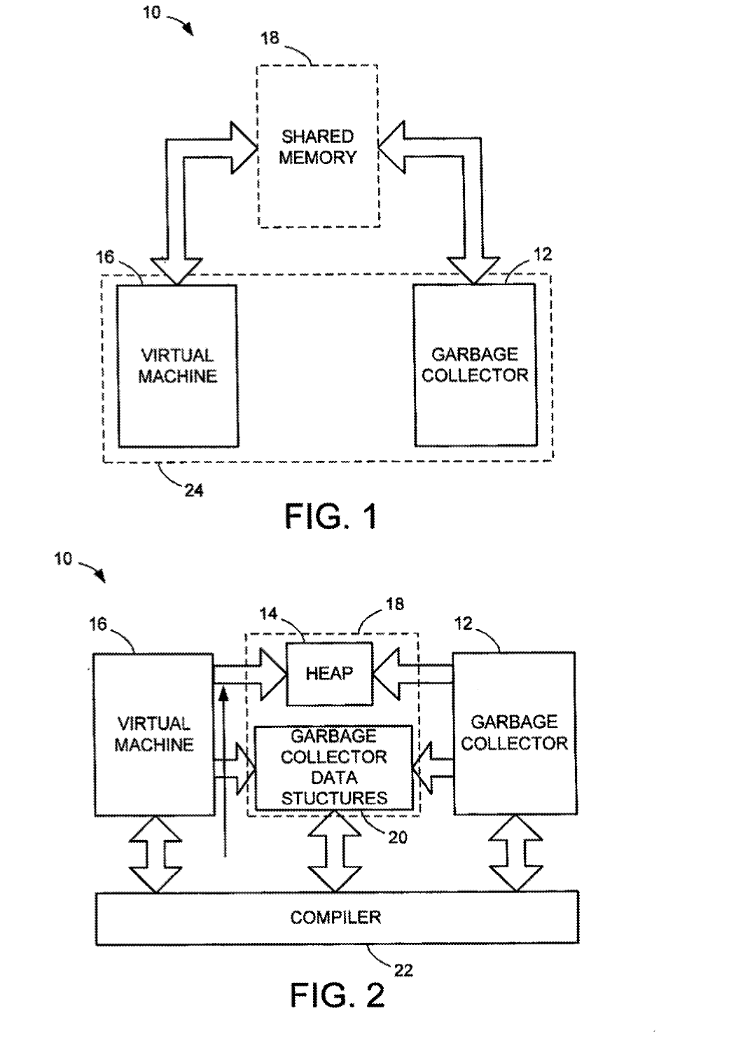

FIGS. 1 and 2 show a system 10 in accordance with various embodiments of the invention. Various embodiments provide an out-of-proc garbage collector 12 which manages the heap 14 (see FIG. 2) for virtual machine 16. The heap 14 resides on a shared memory 18 (see FIG. 1). An out-of-proc activity is one that is performed outside the process (may be in another process) under a trusted environment. In the illustrated embodiments, an out-of-proc activity will utilize resources outside the process in question or have its own set of resources allocated by the operating system.

The system 10 performs the marking, sweeping, and compacting phases in the out-of-proc garbage collector 12 which is forked out during virtual machine initialization. Forking is a mechanism where a running process creates another ‘child’ process. The creator process is called the ‘parent’.

The virtual machine 16 still has the responsibilities of creating the heap 14 and the data structures 20 used by garbage collector in separate shared memory segments. Some of the responsibilities of the garbage collector are now shared with the virtual machine 16 itself.

Initial allocation of the heap 14 and also object allocation now lie with the virtual machine 16. The out-of-proc garbage collector 12 only performs the marking, sweeping, and (if desired) compacting phases. The data structures 20 are shared with the virtual machine process via shared memory segments.

The data structures 20 used by the garbage collector 12 can be categorized into two types: shared data structures and local data structures. Some data structures are shared with the virtual machine 16, such as a free-list data structure. This free-list data structure holds information relating to areas of memory that are up for grabs when an allocation request comes. Examples of local data structures are bit arrays and mark stacks which are used by the garbage collector 12 while cleaning up memory.

The virtual machine/garbage collector interaction is as shown in FIGS. 1 and 2.

There is considerable interaction of the garbage collector with a runtime compiler 22 as well. In some embodiments, the runtime complier 22 is a Just-in-Time compiler similar to the one described in an article titled “Overview of the IBM Java Just-in-Time Compiler” by T. Suganuma, T. Ogasawara, M. Takeuchi, T. Yasue, M. Kawahito, K. Ishizaki, H. Komatsu, and T. Nakatani, published at http://www.research.ibm.com/journal/sj/391/suganuma.html and IBM Systems Journal, Vol. 39, No. 1, incorporated herein by reference. This runtime compiler continues to remain as a part of the main virtual machine process and accesses the necessary data structures related to garbage collector through the shared memory segments.

Synchronization, in the prior art, uses mutexes. A mutex object is a synchronization object whose state is set to “signaled” when it is not owned by any thread, and is set to “nonsignaled” when it is owned. Only one thread at a time can own a mutex object. The object name mutex comes from the fact that a mutex is useful in coordinating mutually exclusive access to a shared resource. To prevent two threads from writing to shared memory at the same time, each thread waits for ownership of a mutex object before executing the code that accesses the memory. After writing to the shared memory, the thread releases the mutex object.

Synchronization is a process to serialize access to shared resources in a multi-tasking environment. In simple terms, synchronization mechanism ensures only one task is accessing a shared resource at any given time. Other tasks contending for the same resource have to wait until the resource is ‘released’ by the task ‘holding’ it.

In some embodiments, synchronization uses semaphores instead of mutexes. Semaphores are variables (utilities), which are used to protect shared resources from contention, which may lead to race conditions.

FIG. 2 illustrates how the compiler, virtual machine, and garbage collector share data structures and the heap from the shared memory.

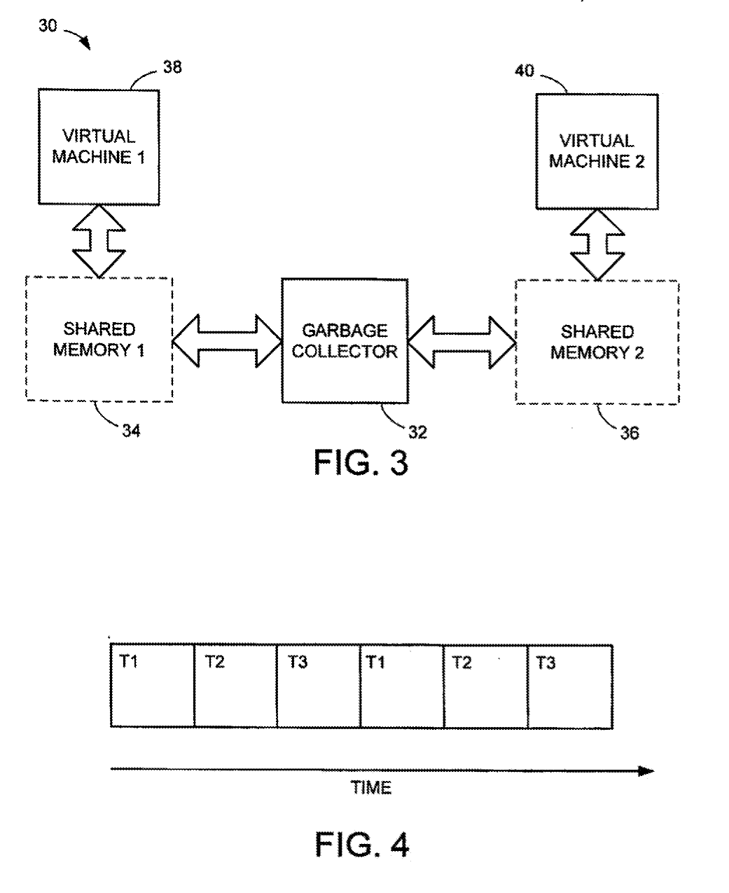

In some embodiments, shown in FIG. 3, one out-of-proc garbage collector 32 in a system 30 can be utilized as a utility to service multiple virtual machines such as virtual machines 38 and 40, with corresponding shared memories 34 and 36, respectively, on the same machine.

Thus, a system and method have been provided with a garbage collector out of the process context of the virtual machine. Thus, there is no need for a stop-the-world phase, as the garbage collector automatically kicks-in during its time slice.

A time slice is a duration of processor time which a process is given before the processor 24 (see FIG. 1) moves on to another process. In some embodiments, a garbage collector runs as a process separate from the virtual machine and has its own share of processor time which is called the garbage collector time slice, as illustrated in FIG. 4. In FIG. 4, T1, T2 and T3 represent time slices for three different processes. Each portion of time marked T2 is a time slice for the garbage collector.

Another advantage is that the garbage collector is time-based rather than asynchronous. Every time the garbage collector gets its time slice, it runs cleaning up the heap. This minimizes interference with throughput as in concurrent garbage collectors, and also avoids pause times due to stop-the-world operation.

In some embodiments, a time-based garbage collector also means deterministic pause times. A deterministic system has time constraints that are very strict, with responses being required within specified amounts of time.

In a traditional virtual machine, garbage collection runs for some amount of time cleaning up the memory. During this time, the virtual machine application is stalled until the garbage collector completes the clean up job. This duration is called ‘pause time.’ The duration of pause time is non-deterministic and is a function of various parameters. In simple terms, in prior art virtual machines, the duration of the time during which the garbage collector runs is variable, and, thus, so is the pause time. In case of frequent garbage collector runs, the amount of uncertainty is greater as the application is stalled for variable amounts of time. In systems or processes which require deterministic behavior, this is not acceptable. Thus, the systems and methods described herein to make the garbage collection time-bound will help.

The time-bound garbage collector of the illustrated embodiments pauses the virtual machine application only for a pre-determined amount of time and then gives the processor 24 back to the application. Thus, pause times become deterministic.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In compliance with the patent statutes, the subject matter disclosed herein has been described with regard to structural and methodical features. However, the scope of protection sought is to be limited only by the following claims, given their broadest possible interpretations. The claims are not to be limited by the specific features shown and described, as the description above only discloses example embodiments.

I/we claim.

1. A method comprising:
initializing a virtual machine; and
defining a garbage collector configured to perform garbage collection in a process separate from the virtual machine, without a stop-the-world phase.

2. The method of claim 1 wherein the garbage collector is forked out during virtual machine initialization.

3. The method of claim 1 wherein the virtual machine has a heap on a shared memory, and wherein the garbage collection is performed on the heap.

4. The method of claim 3, the garbage collection comprising marking and sweeping of the heap.

5. The method of claim 4, the garbage collection further comprising compaction.

6. The method of claim 1 wherein the garbage collector shares at least some data structures with the virtual machine.

7. The method of claim 1 wherein the virtual machine, not the garbage collector, performs initial allocation of objects in a heap.

8. The method of claim 6 wherein the garbage collector has data structures that are not shared with the virtual machine.

9. The method of claim 1 wherein garbage collection occurs during time slices.

10. The method of claim 1 wherein the virtual machine and garbage collector operate in a deterministic manner.

11. A system comprising:
a memory;
a first virtual machine, the first virtual machine being configured to define a heap in the memory; and
a garbage collector configured to be selectively forked out by the first virtual machine and to perform garbage collection on the heap, without a stop-the-world phase.

12. The system of claim 11, further comprising a second virtual machine, wherein the garbage collector is configured to perform garbage collection for both the first and second virtual machines.

13. The system of claim 11 wherein the garbage collector is configured to mark and sweep the heap.

14. The system of claim 13 wherein the garbage collector is further configured to compact the heap.

15. The system of claim 11 wherein the first virtual machine, not the garbage collector, is configured to perform initial allocation of objects in the heap.

16. The system of claim 11 wherein, in operation, the garbage collector has data structures that are not shared with the first virtual machine.

17. The system of claim 11, further comprising a processor configured to allocate processor time slices, wherein different processes are configured to run in different interleaved time slices, and wherein the garbage collector operates during allocated time slices.

18. The system of claim 11 wherein the virtual first machine and garbage collector are configured to operate in a deterministic manner.

19. A computer program product comprising a computer useable medium having a computer readable program, wherein the computer readable program when executed on a computer causes the computer to:
initialize a virtual machine, the virtual machine creating a heap and allocating objects on the heap;
fork out a garbage collector from the virtual machine, the garbage collector configured to perform garbage collection on the heap, the garbage collection including marking and sweeping, without a stop-the-world phase.

20. The computer program product of claim 19 wherein the garbage collector is configured to share at least some data structures with the virtual machine.
